(19) United States
(12) Patent Application Publication
(10) Pub. No.: US 2009/0098273 A1
(43) Pub. Date: Apr. 16, 2009

(54) DEHULLING WHEAT GRAINS USING OZONE

(75) Inventors: Christian Coste, Loriol Du Contat (FR); Michel Dubois, Buc (FR); Anne-Gaëlle Pernot, La Chapelle Des Fougeretz (FR)

Correspondence Address: DENNISON, SCHULTZ & MACDONALD, 1727 KING STREET, SUITE 105, ALEXANDRIA, VA, 22314, US

(73) Assignee: GREEN TECHNOLOGIES, Saint Malo (FR)

(21) Appl. No.: 12/282,032

(22) PCT Filed: Mar. 19, 2007
(86) PCT No.: PCT/FR2007/050942

§ 371 Date: Oct. 15, 2008

(30) Foreign Application Priority Data
Mar. 20, 2006 (FR) 0650952

(51) Int. Cl. B02B 1/04; B02B 3/00

(52) U.S. Cl. 426/627; 426/482; 426/483; 426/618; 99/526

(57) ABSTRACT

The present invention relates to a process for skinning wheat grains and to the products obtained with said process, namely skinned wheat grains and the separated outer skin fragments. It also concerns a specific installation to implement this process. The wheat grain skinning process of the invention notably comprises the following steps:
a) cleaning the raw wheat grains;
b) moistening the cleaned wheat grains;
c) contacting the wheat grains with ozone, after or at the time as their moistening at step b);
d) separating the detached outer skin fragments from the mass of grains partly or wholly skinned at step c).

### FIELD OF THE INVENTION

The present invention relates to a process for skinning the outer layers of wheat grains and to the products obtained with said process, namely skinned wheat grains and the separated outer skin layers. It also concerns a specific installation to implement this process.

The invention finds particular application in the area of industrial milling and specialised milling. It is to be noted that the obtaining of compositions from wheat grains under strict control, as is possible under the invention, is of major interest in the area of dietetics. Compositions of this type can also find application in the areas of cosmetics, pharmacy and fine chemicals.

Wheat is a higher angiosperm i.e. its seed is not bare but is covered by husks. The wheat embryo only has one cotyledon, and wheat is therefore a monocotyledon. Soft wheat belongs to the genus Triticum in the Graminae family. It is a cereal whose grain is a dry, indehiscent fruit, called a caryopsis, formed of a central grain and outer coats.

The central grain consists of an embryo and starchy endosperm from which flour is produced by successive grinding, sorting and sifting operations. At technological level and for food industry applications, a distinction is made between two main species: soft wheat and hard wheat. It is from soft wheat that flours are produced which are chiefly intended for bread-making, and hard wheat is used to produce semolina used for the preparation of pasta.

The outer husks consist of 6 tissues arranged in successive layers, i.e. from outside to inside the grain:
the epidermis and hypodermis which form the outer pericarp,
the mesocarp and endocarp which form the inner pericarp,
the testa and hyaline layer which ensure the junction with the aleurone layer (the hyaline layer is very thin and practically non-existent in hard wheat).

These two latter layers are very closely joined to the aleurone layer which is part of the starchy endosperm. This close link defines a caryopsis.

A schematic cross-section of a grain of soft wheat is given FIG. 1.

Extraction of flour from wheat grain, an operation commonly called “grinding” is a conventional milling operation. It is the own particular structure of the wheat grain which led to adopting this type of technique.

Compared with other cereals (corn, rice for example) the wheat grain has a crease or furrow resulting from inward folding of the seed coats towards the inside of the grain, over its entire length and on the germ side. The bundles providing nourishment to the grain during its development are located in the bottom of this crease. The presence of this crease determines the manner in which the endosperm is separated from the hulls to extract the flours. The presence of this central crease effectively makes it impossible to remove the husks gradually by abrading the peripheral parts, as in rice milling for example. The extraction of wheat flours requires the prior fragmenting of the grains, then the gradual isolation of the endosperm fractions from the innermost parts of the grain i.e. from the centre towards the periphery. This is why the first flours obtained, derived from the centre of the grain, are the purest.

The conventional milling process, by successive grinding, sorting and sifting, allows the peripheral parts to be separated from the starchy endosperm which gives the flour. The separating of the outer layers of the endosperm from the inner layers of the peripheral coats is a delicate operation highly dependent on specificities of varieties and which, at all events, is not perfect.

The flour from soft wheat is obtained by grinding the central part of the grain called the “kernel”. Flour is therefore the noble product derived from the wheat grain. The peripheral parts of the wheat grain, separated from the kernel during grinding, form the by-products. Amongst these by-products “bran”, the residue after wheat grinding, represents approximately 10%. Bran has the reputation of being solely formed of the outer peripheral parts, but it always contains some granules of starch from the endosperm. The other fraction is a very fine mixture of peripheral parts and fine kernel parts commonly called “wheat shorts”. This final grinding fraction is a close-knit mixture of fine peripheral parts and fine endosperm parts.

Semolina mills, which treat hard wheat, essentially differ in the choice of semolina derived from the first grinding operations.

The grain chiefly consists of starch (approximately 70%) proteins (10 to 15%, depending on varieties and growing conditions) pentosans (8 to 10%) lipids (around 1.5%) and other quantitatively minor components such as lignin, cellulose, free sugars, minerals and vitamins.

These constituents are unequally distributed within the different histological fractions of the grain. Starch is entirely found in the starchy endosperm; the protein contents of the germ and aleurone layer are particularly high, mineral matter abounds in the aleurone layer, pentosans are the most important molecules of the aleurone cell walls. Cellulose and lignin represent nearly 50% of the pericarp constituents. Lipids account for approximately 10% of the germ and aleuronic layer.

The peripheral parts of the grain are the richest in mineral matter (around 2.8%). Conversely, the starchy endosperm only contains around 0.5% thereof, and even less is found in the core of the grain. As a consequence, the mineral matter content of flour is used as criterion for its purity i.e. its non-contamination by the peripheral parts of the grain, legal flour types being based in most countries on this content. The “ash curves” (cf. FIG. 2) are used by millers to monitor the proper adjustment of their mill.

This evidently applies to the obtaining of so-called white flours, whose nutritional value is increasingly being placed in question.

The outer peripheral parts are known to be rich in mineral salts, vitamins, soluble and insoluble fibres. To meet new nutritional requirements, flours need to contain a certain percentage of these outer parts of the wheat grain to provide our bodies with the mineral salts, vitamins, fibres necessary for proper nutritional balance.

A distinction can be made between two areas of the outer peripheral parts of the wheat grain, which are generally found in bran:
the outermost parts (outer and inner pericarp), the richest in fibre (lignin, cellulose, hemicellulose); and
the innermost parts which comprise the aleurone layer having a richer content of vitamins, proteins and pentosans (or hemicellulose).

The milling techniques currently used do not allow differentiation and separation between these different layers, which means that if it is desired to obtain flours richer in peripheral layers, part of the bran and/or wheat shorts have to be re-added to these white flours, with no possibility of distinguishing between the two.

From the foregoing, the advantage can be understood of being able to control the separation of the successive layers of wheat grain, in order to obtain flours of constant, adaptable (bio)chemical composition.

It is also of considerable interest to be able to provide whole, undamaged wheat grains from which a controlled number of upper layers have been removed. In the food industry today there are different applications or demands for whole wheat grains that are undamaged, devoid of a controlled number of upper (peripheral) layers. Amongst such applications, the following may be mentioned:
precooked wheats which can be used as vegetables,
precooked wheats which can be used in mixes or to prepare specific sauces,
puffed wheats for breakfast,
addition wheat grains to be used in some bread or pastry preparations containing whole grains,
any industrial food preparation containing whole grains,
any dairy preparation containing whole grains or fractions of whole grains.

The outer layers of wheat also find application in the food industry having regard to the advantage of fibres for intestinal transit, immunity stimulation and protection against some types of cancers. There is an obvious interest in the possible preparation of said outer layers in fully reproducible manner.

Outside the food industry, skinned wheat grains and outer wheat layers of fully controlled composition can find application in the areas of fine chemicals, pharmaceuticals and cosmetics e.g. for coating active substances.

### PRIOR ART

Under the present invention, by “skinning” is meant a process by which the outer peripheral parts of the wheat grains are obtained in the form of thin, elongate flakes. These long flakes consist of a limited number of cell layers, which accounts for their narrow thickness and their translucent appearance. As is explained further on, this translucent appearance is amplified by the action of ozone according to the present invention. These cell layers histologically correspond to the epidermis, hypodermis, mesocarp and endocarp.

By “hulling” is meant a process in which the outer peripheral parts of the grains are obtained in dust form, or fine particles of said peripheral parts, or very fine particles of said peripheral parts.

There are a certain number of patent applications relating directly or indirectly to the hulling of wheat or cereal grains.

FR 1 523 539 for example describes a hulling device comprising additional moistening of the grains before the actual hulling operation, followed by the hulling operation properly so-called performed by applying mechanical energy to rotors to ensure hulling and partial abrasion of the grains.

EP 0 145 600 describes a hulling device for hard grains and its application to the isolation of pure polysaccharides. This document particular addresses carob grains and describes a hulling system which uses infrared radiation in lieu of the use of mineral acids, followed by heat treatment.

FR 2 606 670 describes a shelling device using mechanical means with multiple rotors, particularly adapted to the hulling of sweet white lupin. Shelling is based on intense mechanical action applied to a series of rolls of differentiated geometry.

FR 2 607 027 describes a de-husking device which applies mechanical energy using a rotor having special constructional arrangements. This device was developed in particular for the hulling of millet and sorghum.

WO 88/05339 describes a de-husking device which applies mechanical energy to a rotor of special shape paired with a stator also of special shape, this assembly being developed to avoid the crushing of the grain observed on prior art hullers.

EP 0 820 814 describes a husking device which applies mechanical energy to rolls which are coated with rubber to ensure maximum friction when the grains pass through the space arranged between the two rolls. This space can be adjusted in relation to the extent of husking the user wishes to obtain.

EP 0 427 504 describes a grain husker and in particular a special shape of rotor and stator taking part in the mechanical husking action.

Aside from the above-mentioned patent applications, there are two industrial devices on the market today which can be used by a miller wishing to hull grains before their grinding.

These are:
The DC-Peeler® developed by Bühler and particularly dedicated to the hulling of wheat (hard heat or soft wheat).
The Peritec® Wheat Debranning System (VCW) developed by Sataké and dedicated to the hulling of rice, wheat, barley and the extraction of maize germ.

The changes brought by these devices in a conventional milling line will be better understood on comparing FIGS. 3 and 4.

FIG. 3 shows a conventional milling line, from the storage of raw wheat up until flour is obtained. The main components of this line are:
storage of raw wheat in silos, natural humidity of between 12 and 14%,
cleaning of the raw wheat,
moistening phase intended to bring wheat humidity up to between 16 and 17% (addition of approximately 4 wt. % water),
wheat tempering phase in the silo, for between 24 and 48 hours,
actual grinding, and the production of flour.

FIG. 4 shows a conventional milling line in which the DC-Peeler® or Peritec® device has been inserted. The main components of this line are:
silo storage of raw wheat, natural humidity of between 12 and 14%,
cleaning the raw wheat,
moistening phase intended to bring wheat humidity to between 16 and 17% (addition of approximately 4 wt. % water),
tempering phase, for 24 to 48 hours,
second moistening phase, prior to hulling,
hulling process,
actual milling and the production of flour.

It will be seen that the process with these devices involves additional moistening of the grains before they are placed in the huller. This further moistening step comes in addition to the first conventional moistening step, and is conducted immediately after the tempering phase.

Hulling is obtained by applying mechanical energy to a rotor paired with a stator, called a “mantle”. The Peritec® device does not in fact perform hulling, but rather abrasion of the peripheral parts of the grain, in which it differs from the DC-Peeler® device. Abrasion is obtained by applying mechanical energy to the rolls. The grain to be abraded circulates in the space arranged between the two rolls. This space is adjustable in relation to the desired extent of abrasion in one pass. This sequential device, through internal re-circulation, allows the grain to undergo several passes between the rolls, which increases the extent of abrasion.

It will be noted that the two devices currently marketed both use mechanical energy to ensure hulling or abrasion, and prior additional moistening.

Generally the overall electric energy used by these machines lies between 8.5 kW/tonne of grains and 15 kW/tonne of grains, depending on the mass flow of the machine, in relation to the type of grain to be hulled and in relation to the desired extent of hulling.

### SUMMARY OF THE INVENTION

There remains a need in the area of milling to provide a process for the skinning of wheat grains, involving minimum energy costs, a reduced number of steps and hence of limited duration. There is also a need to control the separation of the outer layers of the wheat grains so as to obtain flours having reproducible compositions, and to provide wheat grains that are controllably skinned able to be used for applications such as pre-cooked wheat grains, breakfast cereals etc. Aside from applications of skinned wheat grains and outer wheat skin layers in the food industry, the precise compositions of carbohydrates, proteins etc. in some fractions of wheat grains allow applications to be considered in the areas of fine chemicals, cosmetics and pharmaceuticals.

It has now been discovered in surprising manner that the problems mentioned above can be globally solved by treating the grains with an ozonated carrier gas. The treatment induces homogeneous skinning of these grains, with no application of any additional energy and without having recourse to mechanical means to apply this additional energy. In other words, the homogeneous skinning achieved is of physicochemical origin and not, as in the prior art, of purely mechanical origin.

Therefore according to a first aspect the present invention relates to the use of ozone to skin wheat grains. The present invention relates in particular to a method to skin wheat grains comprising the following steps:
a) cleaning the raw wheat grains;
b) moistening the wheat grains thus cleaned;
c) contacting the wheat grains with ozone, either after or at the same time as the moistening step b);
d) separating the outer skin layers from the mass of grains fully or partially skinned at step c).

According to a second aspect, the present invention relates to products which may be obtained with the process of the invention, namely skinned wheat grains and the separated skin layers. The present invention also relates to the use both of the skinned wheat grains and of the skin layers for fine chemicals, pharmaceuticals and cosmetics, e.g. to coat active ingredients.

According to a third aspect, the present invention relates to a specific installation to implement this skinning process. The installation of the invention particularly comprises:
a) means 5 to clean said wheat grains;
b) means to moisten said wheat grains;
c) an ozonation reactor 7 allowing the contacting of said wheat grains with the ozone contained in a carrier gas and/or with ozonated water; and
d) a device 10 allowing the skin layers to be separated from the ozone-treated wheat grains.

The applicant, in patent application WO 01/43556 has already described the characteristics and operating parameters of a process intended to decontaminate grains before grinding. In this document it is described that the treatment of wheat grains by an ozonated carrier gas in a sealed enclosed reactor, with internal re-circulation under slight gas pressure, brings a reduction in the microbiological content, the removal of residues of pesticides and the removal of mycotoxins. In this prior application, essentially concerning the manufacture of flours of high food-safety grade, the use of ozone to ensure the skinning of grains is in no way envisaged.

### BRIEF DESCRIPTION OF THE FIGURES

FIG. 1 shows a schematic cross-section of a soft wheat grain (schematic supplied by INRA).

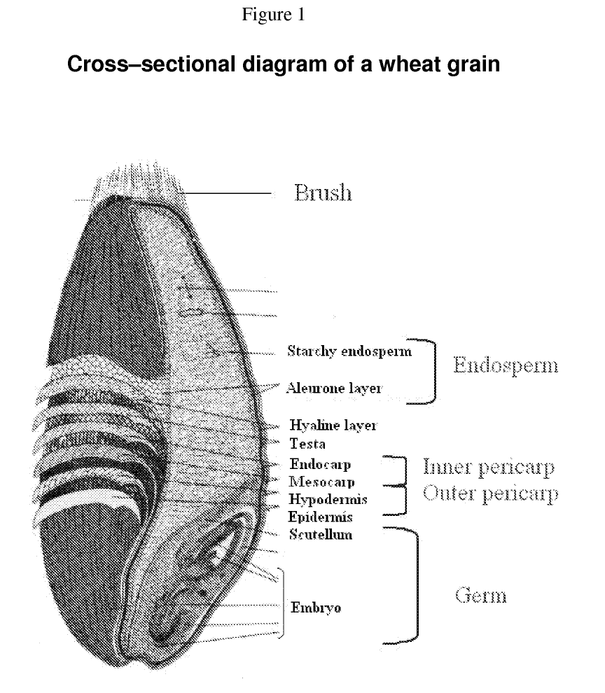

FIG. 2 shows a typical example of an “ash curve”.

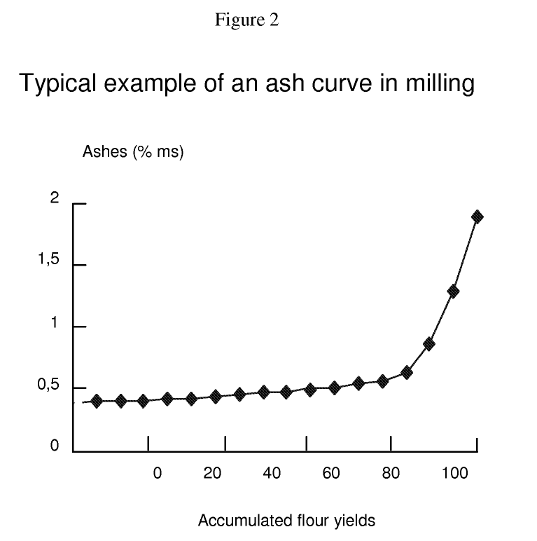

FIG. 3 illustrates a conventional milling line, from the storage of raw wheat up until flour is obtained.

FIG. 4 illustrates a conventional milling line in which the DC-Peeler® or Peritec® device has been inserted.

FIG. 5 illustrates a process of the invention.

FIGS. 6 and 7 are photographs of wheat skin flakes obtained according to the invention.

FIGS. 8 and 9 are photographs of skinned wheat grains obtained according to the invention.

FIG. 10 is a view of skinned wheat grains using the process of the invention and the corresponding skin flakes, after separation.

FIG. 11 is a schematic illustration of a currently preferred embodiment of an installation enabling wheat grains to be treated according to the invention.

### DETAILED DESCRIPTION OF THE INVENTION

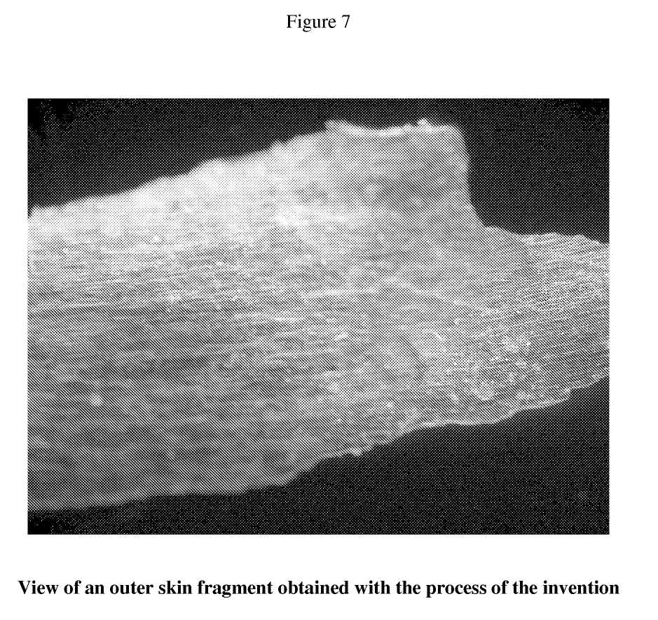

FIG. 5 illustrates the process of the invention.

The chief components of this scheme are:
the silo storage of raw wheat, whose natural humidity lies between 12 and 14%,
cleaning of the raw wheat,
the moistening phase, intended to bring wheat humidity up to a controlled range (the humidity of the grains is measured by hydrometry or weighing). If it is intended to grind the grains to prepare flour, the humidity of the grains is generally brought to a value of between 16 and 17 wt. % of water relative to the total weight of the moistened grains, through the addition of approximately 4 wt. % water. It is important to note however that, for applications in another area (fine chemicals, cosmetics, pharmacy) any water content can be used at this stage preferably between 13 and 35 wt. % water relative to the weight of the moistened grains. Regarding the pH of the treated grains, this is not particularly limited but is generally neutral i.e. between 6.5 and 7.5, and preferably between 6.9 and 7.1
a treatment process of the grains with ozone, and
actual grinding, and production of flour

As specified in the preceding paragraphs, conventional moistening of wheat can be performed directly in the reactor in which ozone treatment is conducted, which is evidenced by the variant in the schematic through use of the conjunction “or”. In this configuration, the main components of the scheme are:
silo storage of the raw wheat, natural humidity between 12 and 14%,
cleaning the raw wheat,
ozone treatment of the grains with moistening of the grains to a predefined level, and
grinding properly so-called, and production of flour.

It is to be noted that in this configuration as in the preceding one, skinning is performed during treatment of the grains with ozone. The detached peripheral parts are separated from the grains on completion of the ozone treatment, before the grains enter the grinding phase for milling applications.

Regarding the means used to fully separate the skin layers which are more or less detached from the wheat grains during their ozone treatment, in particular when emptying the reactor, there are various devices which are able to ensure said separation.

As a general rule, any separation device which functions along the principle of weight difference or density difference can be used to separate the previously treated grains from the skin layers detached by physicochemical effect (subject of the invention).

A first device which can be used is a device of cyclone type ensuring separation of the treated grains and skin layers by centrifugal effect generated by an airflow. Such device is inserted in particular after the lower hopper which collects the grains after treatment. On leaving this lower hopper, the grains generally enter a proportioning chamber ensuring transfer of the grains towards a pneumatic conveying circuit. It is the global airflow rate ensuring pneumatic conveying which generates the centrifugal effect of the cyclone. The grains separated from their skin layers by the cyclone can therefore be extracted by discharge from said cyclone, while the skin layers driven by the airflow are extracted from the cyclone in the upper central part. The mixture of skin layers+conveying airflow is generally directed towards a filter ensuring the separation of the skin layers from the airflow, and correlatively ensuring the retention of fine powder. In some cases, this filter may be seconded by a second air filter, exclusively separating fine powder. In other words, the first filter ensures the separation of the skin layers from the airflow and fine powder, while the second filter rids the airflow of all fine powder.

A second device which can be used is a device with vibrating screens. The airflow used to convey the grains leads the grains towards the inlet of a vibrating screen guided in a fast back and forth horizontal movement, this vibrating screen naturally separating the grains from the airflow (this operation can be conducted by several screens mounted in series). The sorted grains, separated from the airflow, are collected in the lower part of the vibrating screen, while the airflow used to convey the grains is directed towards a dust filter ensuring retention of powder particles and their separation from the airflow.

A third device which can also be used is a device with vibrating screens to which an airflow perpendicular to the tables is applied, allow densimetric sorting. The grains are collected as they exit the vibrating screens, while the skin layers are carried away both by the perpendicular airflow and the driving airflow, generally towards a multi-tiered separating filter device.

According to one particularly preferred embodiment, on leaving the reactor in which the wheat grains are treated with ozone according to the invention, the skin layers can be extracted from the mass of the grains by causing them to pass through a known, conventional separating device commonly called a “winnower”. This device ensures densimetric sorting and separation through the simultaneous application of horizontal vibration generated by a vibrating screen, and application of a rising airflow through the vibrating screen. The conjunction of these two systems considerably minimizes the airflow needed for densimetric sorting, and hence requires much less electric energy to provide the airflow. On leaving this device, the grains separated from the skin layers are collected in a chute and directed towards the grinding operation, whilst the skin layers separated by the airflow are collected and directed towards a storage unit.

For the skinning process of the present invention, the quantity of ozone used preferably lies between 0.5 and 20 expressed in grams of ozone per kilo of grains. The contacting time of the grains with the ozone is preferably between 5 and 70 min, and further preferably between 15 and 40 min. The ozone used is preferably produced from a dry carrier gas, and the ozone concentration in this carrier gas is preferably between 80 and 160 g/m³ NTP, and further preferably between 100 and 120 g/m³ NTP. The pressure of the ozonated carrier gas at the time it is contacted with the grains is between 200 and 800 mbar, preferably between 200 and 700 mbar, and further preferably between 200 mbar or 300 mbar to 600 mbar.

The temperature in the reactor during ozone treatment is generally usual ambient temperature, most often lying between 20° C. and 25° C. at the start of the reaction. Through the exothermal nature of the reaction with ozone, the temperature may rise up to 30° C. or 35° C. or even 40° C. at the end of the reaction. The temperature in the reactor during the reaction is therefore preferably between 20° C. and 40° C. with a starting temperature of between 20° C. and 25° C., and an end-of-reaction temperature with the ozone preferably between 30° C. and 35° C.

According to the present invention, the reactor contacting the wheat grains with the ozone can be supplied indifferently with dry ozone, wet ozone or ozonated water. In one advantageous embodiment, according to the skinning process of the present invention, the water used to moisten the grains is previously treated with ozone. It may be advantageous to combine an ozone supply to the wheat grains in the form of ozonated water with a supply via the gaseous head of the reactor.

The ozone is produced from a carrier gas advantageously consisting of pure oxygen stored in a container. Alternatively the carrier gas may be produced from surrounding air filtered, compressed and dried to dew point between −50 and −70° C. Further alternatively, the carrier gas may consist of a mixture of any proportion of pure oxygen and filtered, compressed and dried air.

Unlike hulling processes known in the prior art, the process of the invention does not require a tempering time following after moistening of the cleaned grains. The possibility of omitting both a tempering phase and a further moistening phase, aside from the other advantages of the present invention, represents a gain in efficiency compared with the prior art.

Under the present invention, the grains are subjected to a first cleaning phase, particularly intended to separate the lightest particles using a blower for example. This step is necessary to eliminate stones, metal particles, dust from the land etc. which contaminate raw wheat when being harvested.

Generally the contacting reactor used in the process of the invention can be vertical, consisting of a cylindrical or cylindrical-conical body with conical base comprising an inner device which provides sufficient grain circulation and residence time in the contacting reactor to ensure optimal ozone treatment. The contacting of the grains with the ozone can be conducted continuously or discontinuously in the reactor. Preferably the reactor allows vertical contacting and comprises an internal grain re-circulating system.

The inner re-circulation rate of the grains (i.e. the number of passes of the grains in the ozone contacting zone) is usually in the order of 10 to 40, and preferably 20 to 30. Inner re-circulation can be ensured by a device of jacketed Archimedes screw type, driven by an electromechanical device allowing the speed of rotation of the screw to be adjusted for precise setting of the desired re-circulation rate, which also depends on the pitch and diameter of the screw.

The contacting reactor is usually provided with an evacuation device to evacuate the reactive gas after the reaction, a spray system for ozonated water fed by piping, a safety device supplied with pressurized water, a safety valve and a shear disk.

In its lower part, the contacting reactor usually comprises an intake and distribution device for ozonated gas, designed so that it ensures distribution of the gas in the mass of grains at a sufficient injection speed to ensure good penetration of the said gas into the mass to be treated. Generally, the injection speed is between 10 and 80 m.s⁻¹ preferably between 30 and 50 m.s⁻¹.

Also, the ozonation reaction being of exothermal type, the body of the contacting reactor is usually provided with a cooling device enabling a constant temperature to be maintained inside said contacting reactor and in the reaction medium, with no vertical or radial temperature gradient, throughout the time needed for the reaction. This efficient cooling of the contacting reactor promotes its safe use, and provides precise control over the ozonating reaction. The cooling device may for example by supplied with cold pressurized water, or via an ice water circuit produced by a refrigerating unit.

The constituent materials of the body of the contacting reactor are chosen so as to ensure resistance to abrasion and oxidation generated by the presence of high concentrations of ozone. Said material may for example be a stainless steel, known to persons skilled in the art.

According to one advantageous embodiment of the present invention, it relates to installations of the type comprising:
a) means 5 to clean said wheat grains;
b) means to moisten said wheat grains;
c) an ozonating reactor 7 allowing the contacting of said wheat grains with the ozone contained in a carrier gas and/or with ozonated water; and
d) a device 10 allowing separation of the skin layers from the ozone-treated grains.

also characterized in that the separating device d) uses an airflow to separate the wheat grains from the skin layers in relation to weight differences or density differences, said separation device being chosen from the group consisting of: a device of cyclone type, a device with vibrating screens, and a device with vibrating screens to which an airflow perpendicular to the vibrating screens is added, and/or

also characterized in that the moistening means b) comprise an inlet for ozonated water 20 in the ozonating reactor 7, said ozonating reactor 7 also comprising an inlet 23 for gaseous ozone contained in a carrier gas.

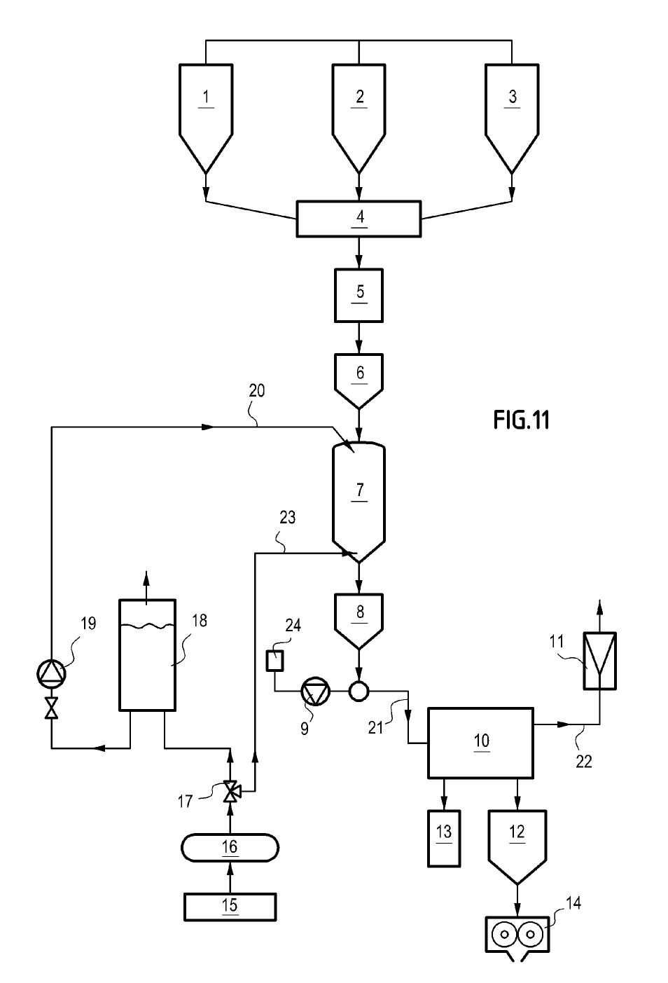

According to one currently preferred embodiment given as a non-limiting example, a global wheat grain skinning device according to the present invention, comprising wheat storage and blending means and means to grind skinned wheat grains for the production of flour is shown FIG. 11. The references in FIG. 11 are as follows:
references 1, 2 and 3 designate the storage silos for raw wheat grains, existing on milling sites,
reference 4 designates the wheat blending system to prepare a typical mix suitable to obtain determined products from different varieties of wheat (stored in silos 1,2,3).
reference 5 relates to cleaning of the wheat grains prior to ozone treatment. This cleaning corresponds to a conventional milling technique and generally comprises several steps.
reference 6 designates a hopper intended to feed the reactor, this hopper can be equipped with automatic weighing devices to determine precisely the quantity of wheat to be added to the ozonating reactor.
reference 7 designates the actual ozonating reactor in which the wheat grains are placed in close contact with the reactive ozone gas. This reactor (reference 7) comprises a water inlet for moistening (reference 20) and an ozonated gas inlet (reference 23).
reference 8 designates an output hopper of the reactor which receives the wheat grains after treatment. This output hopper in its lower part is provided with a feeder device used to place the wheat grains on the pneumatic conveying system (reference 21).
reference 9 designates the air supercharger supplying the grain conveying device. A filter (reference 24) is positioned at the aspiration point of this supercharger for prior filtering of the air before compression.
reference 10 designates the device separating the detached skin layers from the wheat grains. This device of “winnower” type is provided with an inlet for grains and compressed air used for transfer (reference 21), with an air outlet after separation (reference 22), with a separating filter (reference 11), with an outlet for the skin layers and an outlet for the grains towards a wheat collection hopper (reference 12). The “winnower” device is used to separate the treated grains from the skin layers previously detached by physicochemical effect, to collect the grains, and to separate the driving air used in the two preceding phases.
reference 11 designates a separating filter allowing separation of fine dust from driving air. This filter (reference 11) is supplied with a duct (reference 22) ensuring the link between the “winnower” device and the separating filter.
reference 12 designates a wheat collection hopper which receives the wheat separated from the skin layers in the “winnower” device. This wheat collection hopper is also used to feed the grinder (reference 14).
reference 13 designates a device to receive and store the treated skin layers, separated from the wheat grains by the “winnower” device. This storage device for the skin layers protects the latter from outside contamination.
reference 14 designates a conventional grinder allowing flours to be obtained from the treated wheat grains,
reference 15 corresponds to the storage of oxygen intended for the manufacture of ozone. It is the carrier gas used to produce gaseous ozone.
reference 16 designates the ozone generator manufacturing the reactive gas in situ.
reference 17 is a valve system used to direct part of the ozonated gas towards the reactor (reference 7) via a duct referenced 23.
reference 18 designates a device to prepare ozonated water or hyper-ozonated water, to moisten the grains.
reference 19 designates the accelerator pump allowing injection of the water needed to moisten the grains, inside the reactor (reference 7) using the channelling device reference 20.
reference 20 designates the channelling device connecting the ozonated water pump (reference 19) to the reactor (reference 7).
reference 21 designates the duct conveying the wheat grains, skin layers and driving air between the hopper (reference 8) and the “winnower” device (reference 10).
reference 22 designates the duct linking the “winnower” device (reference 10) to the separating filter (reference 11), this duct conveying the driving air and fine dust in suspension.
reference 23 designates the duct conveying the gaseous ozone between the valve system (reference 17) and the reactor (reference 7).
reference 24 designates a dust separating filter mounted at the aspiration point of the air supercharger (reference 9) which ensures the supply of driving air to convey the wheat and skin layers between the feed hopper and the “winnower” separating device (reference 10).
   Results: Comparison of the Process According to the Invention with Prior Art Methods

### Process Simplification and Reduced Energy Costs

Comparison of the processes according to the invention and according to the prior art (DC-Peeler® or Peritec® which act by applying mechanical energy to devices ensuring friction or abrasion of the grain) shows the simplification brought by the process of the invention which treats, decontaminates and skins the wheat grains in a single operation and also does away with the silos needed to ensure tempering after moistening, the time needed for this tempering varying between 24 and 48 hours. The same comparison shows the complexity of the conventional line, when hulling is to be performed, since this operation requires the addition of a further moistening operation. Not only is a tempering phase after moistening of the grains prior to hulling no longer necessary with the present invention, in which skinning is achieved using ozone, but also it is also preferable not to make any provision for a tempering phase at this stage. Savings in time and more efficient use of grain treatment equipment, with a higher production speed compared with known processes, can therefore be achieved.

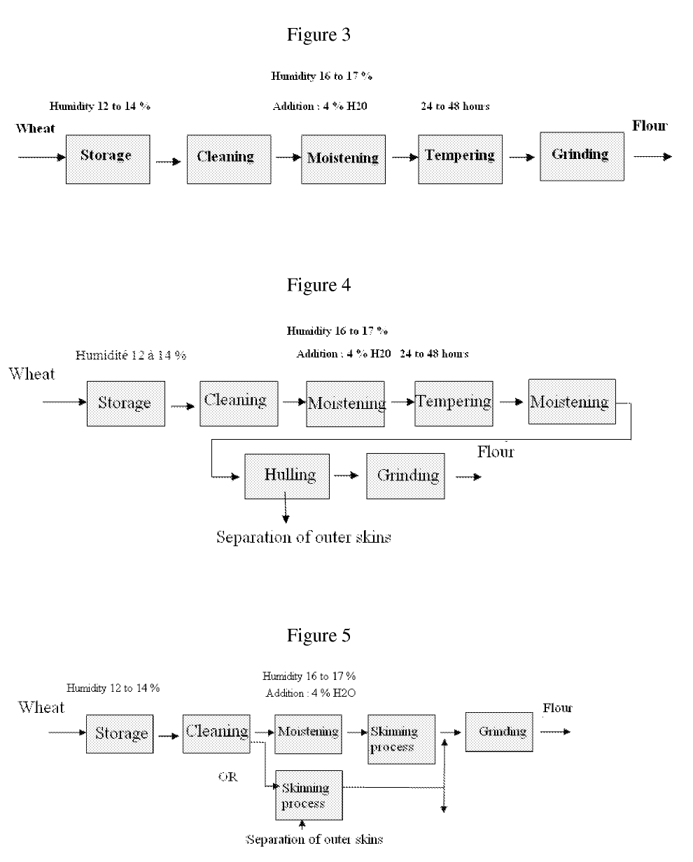

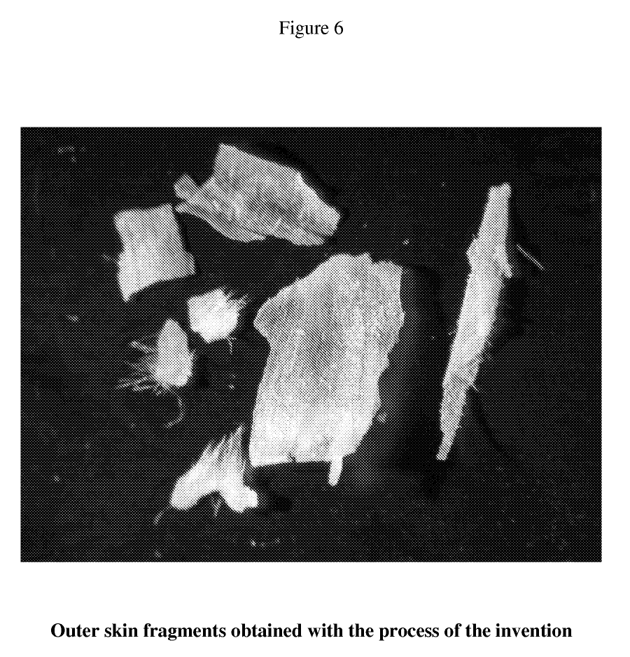

With respect to process time, starting from the beginning of the moistening step up until the start of the grinding phase, a conventional line such as shown FIG. 3 most often entails a time of around 10 minutes for the moistening phase and 24 to 48 hours for the tempering time. Since the two steps come between prior cleaning and grinding, they therefore require from approximately 1 day (+moistening time) up to 2 days (+moistening time). It is to be noted that in practice these processes are mostly continuous, and hence these times represent the transit times for a given mass (e.g. one tonne) of wheat to be treated. On a conventional grinding line in which the DC-Peeler® or Peritec® device has been inserted, such as shown FIG. 4, the total time from the start of moistening up until the start of grinding is at least slightly more than 1 day and at the most slightly more than 2 days. Although the moistening and hulling steps are relatively quick (in the order of 10 minutes), the compulsory tempering phase makes the overall process relatively time-consuming. On the other hand, according to the process of the invention, the duration of the steps between the end of cleaning and the start of grinding i.e. moistening and skinning which can take place at the same time, is generally less than 75 minutes. The elimination of the tempering phase therefore has a considerable influence on the total duration of the process and on optimised use of the reactor.

The insertion in a conventional grinding line of a hulling process of DC-Peeler® or Peritec® type leads to an additional energy consumption of 8.5 to 15 kW/tonne of hulled wheat, and an additional energy consumption of 0.8 to 1.3 kW/tonne to ensure separation of the outer fragments removed from the grain mass. Overall, the insertion of these devices in a conventional grinding line leads to an additional energy consumption of between 9.3 and 16.3 kW/tonne.

If consideration is given solely to the removing of the outer skins, the insertion of the process according to the invention in a conventional grinding line leads to an additional energy consumption of between 0.4 and 0.9 kW/tonne, solely for separation of the outer skin layers from the wheat grains. Giving consideration to the production of ozone, it is estimated that process of the invention generally requires a total consumption of 6.4 to 6.9 kW/tonne of grains for treatment using one kg of ozone per tonne of grains.

Characteristics of the Skin Layers Obtained with the Invention

Under the present invention, the wheat grain skin layers extracted after ozone treatment are white and translucent. Owing to their high degree of decontamination they are perfect for reuse, either as additions to mixes or flour preparations or to animal feeds.

Table 1 below shows the comparison of the physical characteristics of the outer skin fragments obtained with the different processes, it being pointed out that the water content is adjusted so as to allow subsequent grinding for the production of flour for milling applications. If the process of the invention is to be used for the preparation of wheat grains and skin fragments for other functions, different water contents may be contemplated.

TABLE 1
Comparison of the physical characteristics of the outer
fragments obtained with the different processes.

| | | H₂0 content | | Layers |
|---|---|---|---|---|
| | Length (μm) | (%) | Colour | concerned |
| DC-Peeler ® | 1000-3000 | 25 | reddish | Down to the |
| | | | | testa |
| Peritec ® | ≦100 | 25 | reddish | Dependent on |
| | | | | n° of passes |
| Present | 1000-5000 | 18 | white | Down to the |
| invention | | | | testa |

If a comparison is made (column 1, table 1) between the length of the outer fragments expressed in μm, it is ascertained that the outer fragments derived from the DC-Peeler® process have a length of between 1000 and 3000 μm, which indicates the application of mechanical energy involving a friction phenomenon.

The Peritec® process generates outer fragments whose length is 100 μm or less, which is indicative of the application of mechanical energy involving an abrasion phenomenon.

The process of the invention generates outer fragments whose length is between 1000 and 5000 μm, this longer length of the outer fragments being related to the fact that they are detached by physicochemical effect and therefore maintain size integrity.

If a comparison is made (column 2, table 1) between the water content of the outer fragments, it is clear that the DC-Peeler® process and Peritec® process generate outer fragments that are much more hydrated than with the ozone treatment process of the invention.

This can be accounted for by the fact, already analysed, that the DC-Peeler® and Peritec® processes require additional hydration just before the hulling process. The ozone treatment process of the invention however does not require additional moistening prior to treatment of the wheat grains, the residual humidity of the outer fragments being that existing at the time of treatment. Therefore according to one preferred embodiment of the invention, it relates to outer fragments of wheat grains having a water content relative to the weight of the humidified fragments of between 15 and 20%, preferably between 16 and 20%, and further preferably between 17 and 19%.

If a comparison is made (column 3 table 1) between the colour of the outer fragments, it is ascertained that the DC-Peeler® process generates outer fragments of reddish colour, that the Peritec® process also generates outer fragments of reddish colour, whereas the process with ozone treatment according to the invention generates outer fragments of white colour. Ozone effectively has the property of bleaching lignin-cellulose structures, typically found in the peripheral parts of wheat grains.

The outer fragments obtained with the process of the invention also have the special physical characteristic of being translucent, which is indicative of the thinness of the removed layer, unlike the two other processes of mechanical origin which mechanically pull off or abrade the wheat grains.

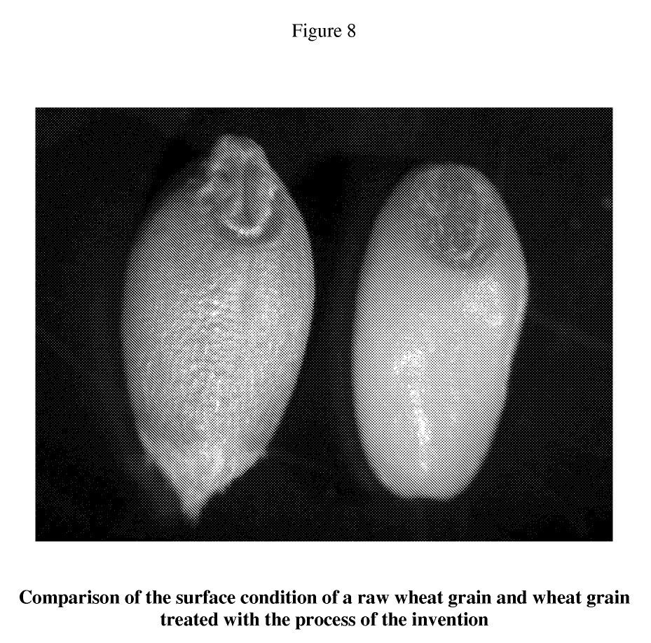

This particular characteristic is fully evidenced by the photos in FIGS. 6 and 7.

The skinned wheat grain after ozone treatment still contains three peripheral histological layers: the testa, hyaline layer and aleurone layer. These three layers are slightly modified through the application of the process of the invention. These changes particularly concern the conversion of part of the insoluble fibres into soluble fibres. These changes are generally considered to be a marked improvement in nutritional terms. Quantitatively, it can be considered that approximately 5% of insoluble fibres are converted into soluble fibres. In parallel, the soluble fibres increase from around 5% (initial percentage) to 10% of total fibre (percentage after treatment) which represents a distinct advantage regarding nutritional and health aspects (intestinal transit, immunity stimulation, protection against certain types of cancers . . . ). The following table evidences this change in fibre content of the outer fragments, and of the bran, compared with bran conventionally obtained without any prior treatment.

TABLE 2
Analysis of skin layers and peripheral parts obtained
after treatment with ozone according to the invention.

| Content | | | | | | |
|---|---|---|---|---|---|---|
| (in g per | Skin layers | | | | | |
| 100 g of skin | of the | | Bran of the | | Usual bran | |
| layer or bran) | invention | | invention | | yield | |
| Soluble fibres | 10.6 | 18.09% | 4.38 | 10.61% | 2.4 | 5.88% |
| Insoluble fibres | 48 | 81.91% | 36.88 | 89.39% | 38.4 | 94.12% |
| Total fibres | 58.6 | 100.00% | 41.25 | 100.00% | 40.8 | 100.00% |
| Lignin | 23.2 | 45.05% | 10.41 | 23.91% | 10.9 | 25.29% |
| Cellulose | 21.7 | 42.14% | 9.53 | 21.87% | 10.5 | 24.36% |
| Hemicellulose | 6.6 | 12.82% | 23.62 | 54.23% | 21.7 | 50.25% |
| Insoluble plant | 51.5 | 100.00% | 43.56 | 100.00% | 43.1 | 100.00% |
| walls | | | | | | |

The present invention also relates to the production of marketable, thin outer fragments having particular biochemical characteristics (cf. table above). The particles obtained with hulling cannot be marketed as such, having regard to the concentration of undesirable contaminants. On the contrary, the outer fragments produced with the process developed by the applicant form an original product, which can be used as such and offers novel nutritional characteristics for which there is a market demand. In particular these outer fragments have unequalled food fibre content, they are white, thin, translucent and lend themselves to multiple transformation operations.

Characteristics of the Skinned Wheat Grains Obtained with the Invention

As indicated in column four of table 1 above, the DC-Peeler® process reaches the so-called testa layer, while the Peritec® process may go beyond this layer, the abrasion of the wheat grain being closely related to the number of passes of the wheat grains between the abrasion rolls. The process using ozone treatment according to the invention, without having recourse to mechanical adjustments or multiple passes, naturally arrives as far as the testa layer.

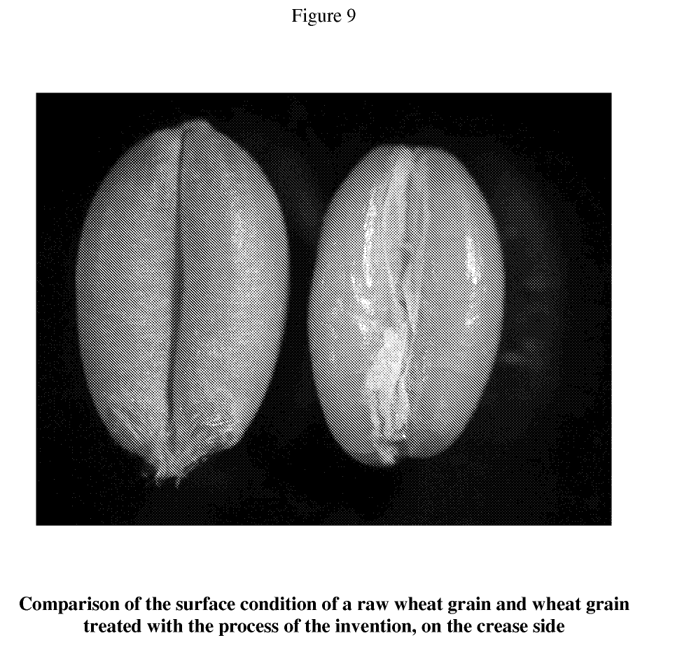

Examination under magnification of an ozone-treated wheat grain according to the invention, compared with a non-treated grain (see FIGS. 8 and 9), shows that the grain treated with the process of the invention (grain on the right side) has a smooth, shiny surface devoid of any raised bumps in which the brush (at the lower end of the grain) has fully disappeared The germ of the wheat grain, located in the upper end of the grain, has also been cleaned and rid of the shell part by which it is naturally protected.

The non-treated grain (on the left in the photo) shows a rough, wrinkled surface and has the brush in its lower part and the protective shell of the germ in its upper part.

The comparison between the two photos clearly shows the effects of skinning obtained using the process of the invention.

If mechanical energy is used to rub or abrade wheat grains, their surface is necessarily less smooth, non-shiny with numerous bumps corresponding to where peripheral parts of the grain have been pulled away. Generally, the surface of a wheat grain treated with the DC-Peeler® process or Peritec® process is much less smooth than the surface of a non-treated wheat grain (raw state).

The DC-Peeler® process or Peritec® process more or less deteriorates the surface quality of wheat grains. This is a direct consequence of the application of mechanical energy in the form of abrasion or friction.

FIG. 9, on the crease side, also shows the surface condition of a raw wheat grain (on the left) compared with a wheat grain treated with the ozone process of the invention (grain on the right).

The same remarks as previously apply to this photo regarding surface quality, shine, removal of the brush and germ shell.

It can also be observed that the skin layer caught in the inward fold of the crease is partly detached, which will contribute towards its full separation at the time of grinding.

If it is desired to fully separate the layer protecting the crease using a mechanical process, it is obvious that abrasion of the grain must be increased to the detriment of maintaining the peripheral parts of the grain.

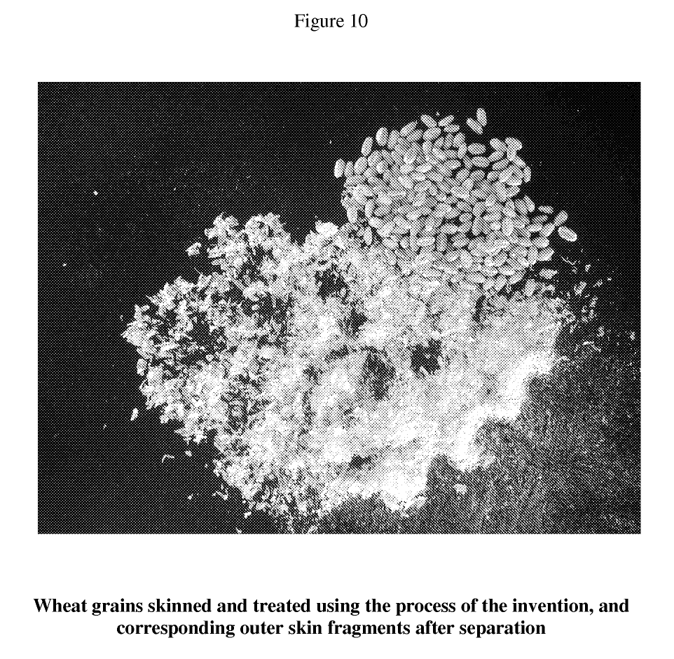

It is clearly evident on examining the above photos that the surface quality of the wheat grain skinned according to the process of the present invention allows any direct use of this grain without necessarily passing through a grinding phase (precooked wheat grains, breakfast cereals . . . ). FIG. 10 shows wheat grains skinned according to the invention, and the corresponding outer skin fragments after separation. The shine of the wheat grains can be observed, as well as the size and white, translucent appearance of these outer skin fragments.

The skinned wheat grains have specific characteristics which open up new possibilities. For example, grains can be obtained whose peripheral part has been modified (cf. table 2), the bran containing more soluble fibres, which is of greater nutritional advantage. Another example: the possible slight, but nonetheless significant modification of the free sugar content, which improves taste (cf. table 3 below).

TABLE 3
modified free sugar content of the wheat grain after treatment.

| | | Wheat treated according |
|---|---|---|
| Quantity of sugars in | | to the invention |
| mg per 100 g wheat | Raw untreated wheat | (optimal conditions) |
| Glucose | 91.40 | 278.40 |
| Fructose | 55.00 | 130.40 |
| Sucrose | 954.60 | 803.00 |
| Raffinose | 208.70 | 220.20 |
| Stachyose | 160.00 | 135.50 |
| Maltose | 218.70 | 2120.20 |
| TOTAL | 1688.40 | 3687.70 |

The skinned grain therefore contains an increased proportion of maltose, a natural sugar of extreme interest for its energy and nutritional aspects. Under this invention, the maltose content can reach up to 2 wt. % of grain starch. The relative quantity of the other sugars is not or only scarcely modified. Therefore according to one advantageous embodiment of the present invention, it relates to skinned wheat grains containing at least 0.5 wt. % preferably at least 1 wt. %, further preferably at least 1.5 wt. % of maltose relative to the weight of the skinned grains.

### EXAMPLE(S) OF EMBODIMENT

By way of example, the applicant provides the following results obtained with soft wheat and with hard wheat.

### Example 1

In a reactor with internal re-circulation, 8.28 kg of soft wheat are added, intended for the production of bread flour. It is a mixture essentially consisting of the Apache and Caphorn varieties, the mixture having been prepared by the Paulic mill in Saint Gerard (22). These 8.28 kg of soft wheat were subjected to ozone treatment under the following conditions:

The concentration of ozone in its carrier gas was 88 g/m³ NTP.

The ozone treatment rate of the wheat grains was 5 g O₃ per kg of dry wheat. The 41.4 g of ozone added (for 8.28 kg of wheat) were entirely added in the form of ozone contained in the carrier gas.

The natural humidity content of the wheat was 13%.

The percentage of water added to the reactor was 4 wt. %.

The overall humidity of the wheat at the start of treatment was 17%.

The treatment time was 30 minutes.

After this treatment, the reactor was emptied and the detached outer fragments were separated from the mass of treated grains by winnowing with addition of an airflow.

Under these operating conditions, the following results were obtained:

| | |
|---|---|
| Weight of grains before skinning | 8.28 kg |
| Weight of outer skin fragments | 0.20 kg |
| % outer skin fragments | 2.42% |
| Weight of grains after skinning | 8.08 kg |

### Example 2

In a reactor with internal re-circulation, 10 kg of hard wheat were added, intended for the production of pasta. It was a mixtures supplied by the Agralis cooperative intended for semolina production. These 10 kg of hard wheat were subjected to ozone treatment under the following conditions:

The concentration of ozone in its carrier gas was 89 g/m³ NTP.

The ozone treatment rate of the wheat grains was 5 g O₃ per kg of dry wheat. The 50 g of ozone added (for 10 kg of wheat) were added entirely in the form of ozone contained in the carrier gas.

The natural humidity of the wheat was 12.41%.

The percentage of water added to the reactor was 5.5 wt. %.

The global humidity of the wheat at the start of treatment was 17%.

The treatment time was 30 minutes.

After this treatment, the reactor was emptied and the detached outer fragments were separated from the mass of treated grains by passing through a winnower with additional airflow.

Under these operating conditions, the following results were obtained:

| | |
|---|---|
| Weight of grains before skinning | 10 kg |
| Weight of outer skin fragments | 0.29 kg |
| % outer skin fragments | 2.9% |
| Weight of grains after skinning | 9.71 kg |

1. Process to skin wheat grains comprising the following steps:
a) cleaning the raw wheat grains;
b) moistening the cleaned wheat grains;
c) contacting the wheat grains with ozone, after or at the same time as their moistening at step b);
d) separating the detached outer skin layers from the mass of grains that is partly or wholly skinned at step c).

2. Process according to claim 1, wherein the quantity of ozone used lies between 0.5 and 20 expressed in grams of ozone per kilo of grains.

3. Process according to claim 1, wherein the contacting time of the grains with the ozone lies between 5 and 70 min, preferably between 15 and 40 min.

4. Process according to claim 1, wherein the ozone used is produced from a dry carrier gas and in that the concentration of ozone in the carrier gas lies between 80 and 160 g/m³ NTP and preferably between 100 and 120 g/m³ NTP.

5. Process according to claim 1, wherein the pressure of the ozonated carrier gas when contacted with the grains lies between 200 and 800 mbar.

6. Process according to claim 1, wherein the water used to moisten the grains is previously treated with ozone.

7. Process according to claim 1, wherein the contacting of the grains with the ozone is conducted continuously or discontinuously in a vertical contacting reactor comprising an internal device to re-circulate the grains.

8. Process according to claim 1, wherein the skin layers which are separated during ozone treatment are extracted from the mass of grains by an airflow allowing densimetric sorting.

9. Process according to claim 8, wherein the densimetric separation of the grains is conducted by simultaneous application of horizontal vibration, generated by a vibrating screen, and a rising airflow through said vibrating screen.

10. Skinned wheat grains obtained using the process of claim 1.

11. Skinned wheat grains according to claim 10, containing at least 0.5 wt. % preferably at least 1 wt. %, further preferably at least 1.5 wt. % of maltose relative to the weight of skinned grains.

12. (canceled)

13. Outer skin fragments of wheat grains obtained according to the process of claim 1.

14. Outer skin fragments of wheat grains according to claim 13, having a water content relative to the weight of the moistened outer skin fragments of 15 and 20%, preferably between 16 and 20% and further preferably between 17 and 19%.

15. Outer skin fragments of wheat grains according to claim 13, wherein they have a length of between 1 and 5 mm.

16. (canceled)

17. Installation to implement the wheat grain skinning method according to claim 1, comprising:
a) means (5) to clean said wheat grains;
b) means to moisten said wheat grains;
c) an ozonation reactor (7) allowing the contacting of the said wheat grains with the ozone contained in a carrier gas and/or with ozonated water; and
d) a device (10) enabling the separation of the detached outer skin fragments from the ozone-treated wheat grains.

18. Installation according to claim 17, wherein the separation device d) uses an airflow to separate the wheat grains from the outer skin fragments in relation to weight differences or density differences, said separation device being selected from the group consisting of: a cyclone type device, a vibrating screen device, and a vibrating screen device to which an airflow has been added perpendicular to the vibrating screens.

19. Installation according to claim 17 wherein the moistening means b) comprise an inlet for ozonated water (20) in the ozonation reactor (7), said ozonation reactor (7) also comprising an inlet (23) for gaseous ozone contained in a carrier gas.

20. (canceled)
